(19) United States
(12) Patent Application Publication
(10) Pub. No.: US 2016/0167056 A1
(43) Pub. Date: Jun. 16, 2016

(54) ORGANIZATIONAL RECYCLING ASSEMBLY AND METHOD OF USE

(71) Applicants: Frank Lawrence Squartino, Cooper City, FL (US); Kory Karl Sgrignoli Jr., Raleigh, NC (US)

(72) Inventors: Frank Lawrence Squartino, Cooper City, FL (US); Kory Karl Sgrignoli Jr., Raleigh, NC (US)

(21) Appl. No.: 14/566,957

(22) Filed: Dec. 11, 2014

(51) Int. Cl. B02C 18/00; B02C 18/22; B65F 1/02; B65F 1/00; B65F 1/14

(52) U.S. Cl. CPC B02C 18/0084; B65F 1/006; B65F 1/1431; B65F 1/02; B02C 18/2216; B02C 2018/162

(57) ABSTRACT

An organizational recycling assembly is disclosed that includes a housing having a shredding assembly disposed within a recyclable waste channel. The shredding assembly is operable to shred and/or crush a piece of consumer waste. The shredding assembly is upstream of at least one waste distribution divider, and a plurality of waste containers disposed below a plurality of recyclable waste distribution channels. At least one button is coupled to the housing and is operably configured to selectively move the at least one waste distribution divider to an open position fluidly coupling the recyclable waste channel to at least one of the first recyclable waste distribution channel and the second recyclable waste distribution channel. The open position results in an alternative recyclable waste distribution channel being sealed from the recyclable waste channel. The waste distribution dividers open and close based on a type of consumer waste selected by a user.

### FIELD OF THE INVENTION

The present invention relates generally to a recycling assembly, and, more particularly, relates to an assembly and method for shredding, crushing, and organizing consumer waste.

### BACKGROUND OF THE INVENTION

The recycling process benefits the environment in a number of ways, including reducing the amount of waste that accumulates at landfills. The recycling process includes converting recyclable materials into new products to prevent wasting of potentially useful materials. Recyclable materials include items such as paper, plastic, cardboard, aluminum cans, glass, and the like. It is well known that recycling assemblies, such as shredding assemblies, benefit the environment by shredding recyclable materials into smaller pieces, thereby reducing the overall size of the recyclable materials in the environment. Furthermore, it reduced the overall financial and mechanical burden of processing the recyclable waste when it reaches a recycling plant. Recycling assemblies are found in both residential and business settings. Naturally, the size and complexity of recycling assemblies varies, according to the setting. Many known recycling assembly process the consumer waste, but fail to organize the material in an effective and efficient manner, if at all.

Some known recycling assemblies sort the recyclable materials into categories prior to shredding. In order to sort the recyclable materials, some of the known recycling assemblies require the piece of recyclable material to be placed in the recycling assembly in a horizontal position so that the sensors on the recycling assembly can properly detect the type of material that is being inserted by the user. Unfortunately, if the recyclable materials are not placed within the machine in the proper position, the recyclable materials often become stuck in the recycling assembly prior to shredding. The blocked materials can create maintenance problems or the need to replace expensive components of the recycling assembly. This is especially true when the piece of recyclable material is a large item, such as a two-liter plastic bottle. Moreover, the recyclable materials may not be sorted into the correct category, thereby creating the time intensive task of sorting the recyclable materials by hand. Problematically, this time intensive task often dissuades many people from recycling from the outset and runs contrary to the purpose of the recycling assembly. Furthermore, several known recycling assemblies do not have the capability to shred or compact glass, or compartmentalize different processing methods within the housing of the recycling assembly, thereby increasing the complexity and size of the device. Moreover, if glass was placed in most known recycling assemblies geared for consumer waste, it would create a hazardous recycling process because errant glass will likely exit the housing or damage the internal components/surfaces of the assembly.

A number of known recycling assemblies are manufactured using numerous moving parts, making the cost of maintenance and repair expensive. Additionally, known recycling assemblies often consume high amounts of energy, thereby increasing utility costs in the residential and business settings.

Therefore, a need exists to overcome the problems with the prior art as discussed above.

### SUMMARY OF THE INVENTION

The invention provides an assembly and method for shredding and organizing recyclable waste that overcomes the hereinafore-mentioned disadvantages of the heretofore-known devices and methods of this general type and that shreds, crushes, processes and organizes recyclable waste.

With the foregoing and other objectives in view, there is provided, in accordance with the invention, an organizational recycling assembly that includes a housing having an outer surface that includes a top surface and a bottom surface. The housing defines a recyclable waste aperture disposed on the outer surface. The recyclable waste aperture is sized to receive a piece of consumer waste. The housing also defines a recyclable waste channel spanning from the recyclable waste aperture toward the bottom surface of the housing. The housing further defines a first recyclable waste distribution channel and a second recyclable waste distribution channel. Both the first and second recyclable waste distribution channels are located downstream the recyclable waste channel and operable to be fluidly coupled to the recyclable waste channel through at least one waste distribution divider. The organizational recycling assembly also includes a shredding assembly disposed within the recyclable waste channel and upstream the at least one waste distribution divider; a first recyclable waste container disposed below, and in fluid communication with, the first recyclable waste distribution channel; a second recyclable waste container disposed below, and in fluid communication with, the second recyclable waste distribution channel; and at least one button coupled to the housing and operably configured to selectively move the at least one waste distribution divider to an open position fluidly coupling the recyclable waste channel to one of the at least one of the first recyclable waste distribution channel and the second recyclable waste distribution channel. The open position results in a closed position with a remaining of the at least one of the first recyclable waste distribution channel and the second recyclable waste distribution channel sealed from the recyclable waste channel. The open position is based on a type of the piece of consumer waste selected by a user.

In accordance with a further feature of the present invention, the organizational recycling assembly includes an enclosure disposed over the recyclable waste aperture and operable to translate from an open position exposing the recyclable waste aperture and a closed position substantially sealing the recyclable waste aperture.

In accordance with an additional feature of the present invention, the organizational recycling assembly includes an electronic display coupled to the housing having the at least one button. The electronic display is communicatively coupled to the at least one waste distribution divider.

In accordance with an additional feature of the present invention, the shredding assembly includes at least three reciprocating blade members extending in a longitudinal direction away from the recyclable waste aperture for processing the piece of consumer waste.

In accordance with another feature of the present invention, the at least three reciprocating blade members taper downwardly in a direction toward the bottom surface of the housing.

In accordance with yet another feature of the present invention, the at least one waste distribution divider is substantially enclosed.

In accordance with an additional feature of the present invention, the organizational recycling assembly includes a first waste distribution divider separating the first recyclable waste distribution channel and the recyclable waste channel; and a second waste distribution divider separating the second recyclable waste distribution channel and the recyclable waste channel, wherein the at least one button is operably configured to selectively move at least one of the first and second waste distribution dividers to the open position.

In accordance with an additional feature of the present invention, the organizational recycling assembly includes a first button and a second button coupled to the housing. The first button corresponds to a user selection of a first piece of consumer waste and is operably configured to selectively move the first waste distribution divider to the open position. The second button corresponds to the user selection of a second piece of consumer waste and is operably configured to selectively move the second waste distribution divider to the open position, the second piece of consumer waste is of a material different than a material of the first piece of consumer waste.

In accordance with yet an additional feature of the present invention, the first piece of consumer waste is of a plastic material and the second piece of consumer waste is of a glass material.

In accordance with an additional feature of the present invention, the organizational recycling assembly includes a third waste distribution divider separating a third recyclable waste distribution channel and the recyclable waste channel. The third waste distribution divider is communicatively coupled to a third button that is operably configured to selectively move the third waste distribution divider to the open position, the third recyclable waste distribution channel located downstream of the recyclable waste channel. A third recyclable waste container is disposed below, and in fluid communication with, the third recyclable waste distribution channel.

In accordance with an additional feature of the present invention, the first button, the second button, and the third button each correspond to a consumer waste of a material different from one another.

In accordance with the present invention, a method of organizing and processing recyclable waste includes the step of selecting, through at least one button coupled to a housing of a recycling assembly, one of a plurality of types of consumer waste for processing by the recycling assembly. The method further includes the step of inserting a piece of consumer waste into a recyclable waste aperture defined by the housing, the piece of consumer waste corresponding to the one of the plurality of types of consumer waste selected by a user. The method continues with the steps of delivering, through a recyclable waste channel defined by the housing, the piece of consumer waste to a shredding assembly disposed within the recyclable waste channel; shredding the piece of consumer waste into a plurality of consumer waste fragments; delivering the plurality of consumer waste fragments to a plurality of waste distribution dividers, each of the plurality of waste distribution dividers corresponding to each of the plurality of types of consumer waste for processing by the recycling assembly; opening one of the plurality of waste distribution dividers based on the one of the plurality of types of consumer waste selected by the user; and delivering the plurality of consumer waste fragments, through a recyclable waste distribution channel defined by the housing, to one of a plurality of containers corresponding to the one of the plurality of types of consumer waste selected by the user, the plurality of containers disposed within the housing.

In accordance with another feature of the present invention, the method includes closing the one of the plurality of waste distribution dividers opened based on the one of the plurality of types of consumer waste selected by the user so as to seal the recyclable waste distribution channel with the recyclable waste channel.

In accordance with another feature of the present invention, the method includes introducing a pressurized fluid, through at least one nozzle, in a direction toward the one of the plurality of waste distribution dividers opened based on the one of the plurality of types of consumer waste selected by the user.

In accordance with an embodiment of the present invention, the organizational recycling assembly includes a housing having an outer surface defining a recyclable waste aperture sized to receive a piece of consumer waste. The housing also defines a recyclable waste channel spanning from the recyclable waste aperture toward a bottom surface of the housing. A single shredding assembly is disposed within the recyclable waste channel. The organizational recycling assembly also includes a first waste distribution divider separating a first recyclable waste distribution channel and the recyclable waste channel, the first recyclable waste distribution channel and the first waste distribution divider both disposed downstream of the recyclable waste channel, the first waste distribution divider communicatively coupled to a first button that is operably configured to selectively move the first waste distribution divider to at least one of an open position with the first recyclable waste distribution channel fluidly coupled to the recyclable waste channel to permit the piece of consumer waste to enter a first recyclable waste container disposed below the first recyclable waste distribution channel and to a closed position with the first recyclable waste distribution channel sealed with the recyclable waste channel. The organizational recycling assembly further includes a second waste distribution divider separating a second recyclable waste distribution channel and the recyclable waste channel, the second recyclable waste distribution channel and the second waste distribution divider both disposed downstream of the recyclable waste channel, the second waste distribution divider communicatively coupled to a second button that is operably configured to selectively move the second waste distribution divider to at least one of an open position with the second recyclable waste distribution channel fluidly coupled to the recyclable waste channel to permit the piece of consumer waste to enter a second recyclable waste container disposed below the second recyclable waste distribution channel and to a closed position with the second recyclable waste distribution channel sealed with the recyclable waste channel.

In accordance with another feature of the present invention, the first and second buttons each correspond to a consumer waste of a material different from one another.

In accordance with yet another feature of the present invention, the first and second containers are slidably, and removably, coupled to the housing.

In accordance with yet another feature of the present invention, the organizational recycling assembly includes a third waste distribution divider separating a third recyclable waste distribution channel and the recyclable waste channel, the third recyclable waste distribution channel and the third waste distribution divider both disposed downstream of the recyclable waste channel, the third waste distribution divider communicatively coupled to a third button that is operably configured to selectively move the third waste distribution divider to at least one of an open position with the third recyclable waste distribution channel fluidly coupled to the recyclable waste channel to permit the piece of consumer waste to enter a third recyclable waste container disposed downstream the third recyclable waste distribution channel and to a closed position with the third recyclable waste distribution channel sealed with the recyclable waste channel, wherein the first, second, and third buttons each correspond to a consumer waste of a material different from one another.

In accordance with another feature of the present invention, the organizational recycling assembly includes at least one nozzle operably configured to introduce a pressurized fluid in a direction toward the first and second waste distribution dividers when either is in the open position.

In accordance with still one more feature of the present invention, at least one of the first and second waste distribution dividers are disposed at acute angle with respect to a plane defined by a general exit direction of the piece of consumer waste as it leaves the recyclable waste channel.

Although the invention is illustrated and described herein as embodied in an organizational recycling assembly and method of use, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the recyclable waste channel spanning from the recyclable waste aperture toward the bottom surface of the housing.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of an exemplary embodiment of an organizational recycling assembly in accordance with the present invention;

FIG. 2 is a cross-sectional view of the housing of the organizational recycling assembly of FIG. 1 along section A-A;

FIG. 3 is a fragmentary top plan view of the organizational recycling assembly of FIG. 1 depicting a shredding assembly disposed therein in accordance with an embodiment of the present invention;

FIG. 4 is cross-sectional view of the housing of the organizational recycling assembly of FIG. 1 along section B-B;

FIG. 5 is an elevational front view of the organizational recycling assembly of FIG. 1;

FIG. 6 is top plan view of a drawer having a plurality of containers utilized with the organizational recycling assembly in accordance with one embodiment of the present invention;

FIG. 7A is a process flow diagram depicting a method of using the organizational recycling assembly of FIG. 1; and

FIG. 7B is a continuation of the process flow diagram of FIG. 7A depicting the method of using the organizational recycling assembly in accordance with FIG. 1.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

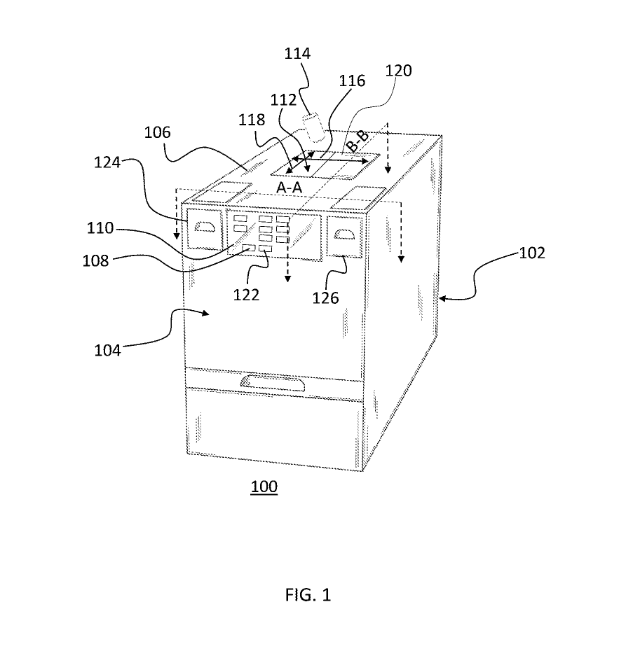

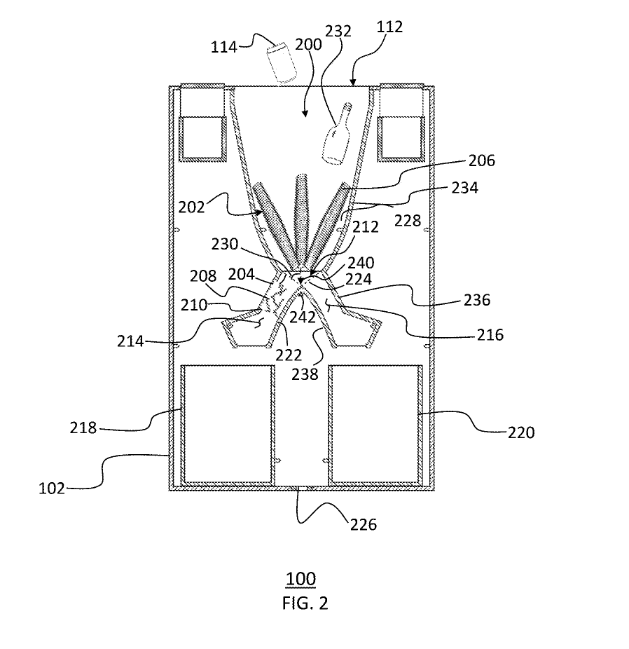

The present invention provides a novel and efficient organizational recycling assembly that is designed to shred, process, and organize consumer waste that is recyclable. Recyclable consumer waste may be any product(s) that people buy for personal use or for use at a home or business. Examples include glass, plastic, cardboard, aluminum cans, Styrofoam, steel cans, paper, and like. With reference to FIGS. 1 and 2, preferable embodiments of the present invention include an assembly 100 with a housing 102 having a central and/or single shredding assembly 202. Advantageously, the present invention provides a configuration of channels and dividers that effectively and efficiently processes and organizes the consumer waste for recycling by a user, and eventually a recycling plant. FIG. 1 is a perspective downward-looking view of the recycling assembly 100 and FIG. 2 is cross-sectional view of the assembly 100 along section A-A. FIGS. 1 and 2 show several advantageous features of the present invention, but, as will be described below, the invention can be provided in several shapes, sizes, combinations of features and components, and varying numbers and functions of the components.

More specifically, the central shredding assembly 202 can be seen located within a recyclable waste channel 200. Once the consumer waste, or recyclable waste, material is shredded by the central shredding assembly 202, the recyclable waste material is routed through a series of channels to a container designated for the particular type of recyclable waste material. The particular type of recyclable waste material processed by the assembly 100 corresponds to the at least one button which is coupled to the housing 102. When pressed by a user, the button causes a waste distribution divider, e.g., divider 204, to open and/or close to permit the recyclable waste material to enter the appropriate distribution channel 214, 216 to reach the designated container. Advantageously, the recyclable waste containers can be removed and emptied, for convenient removal of the recyclable waste from the individual container(s).

The organizational recycling assembly 100 has a housing 102 to encapsulate the internal components, e.g., shredding assembly 202 for protection from the outside environment of the assembly 100. The size of the organizational recycling assembly 100 may vary, but is generally of a height of approximately 3-5 feet and of a width of approximately 2-4 feet. It is also preferable that the overall weight of the assembly not exceed approximately 100 pounds to provide a user with maneuverability and easy transportation. The aforementioned height, width, and weight of the assembly may vary outside of the aforementioned ranges depending on its use and application.

In one embodiment, the material of the housing 102 may be made with a plastic, e.g. ABS plastic, able to withstand forces generated by a shredding assembly 202 contained within the housing 102. In another embodiment, the material of the housing 102 may be made with a steel material. In other embodiments, the housing 102 may be made with a rubber or another similar durable material.

FIG. 1 shows the housing 102 having an outer surface 104. The outer surface 104 is the exterior portion of the housing 102. The outer surface 104 includes a top surface 106 and a bottom surface (not shown). The housing 102, specifically the outer surface 104, defines a recyclable waste aperture 112 disposed on the top surface 106. The recyclable waste aperture 112 is sized to receive at least a piece of consumer waste 114. In one embodiment, the recyclable waste aperture 112 may be a length 116 of approximately 12 inches and a width 118 of approximately 12 inches. In other embodiments, the length 116 and width 118 may vary outside of this range, depending on the overall size of the organizational recycling assembly 100 and the assembly's 100 use and application. Additionally, the recyclable waste aperture 112 may also be defined at another location on the outer surface 104.

Advantageously, the recyclable waste aperture 112 and the recyclable waste channel 200 is sized to receive the piece of consumer waste 114, e.g., a can, from various angles and without regard to the orientation of the recyclable waste, i.e., either a vertical orientation, a horizontal orientation, or any combination of the same with respect to the shredding elements 208 within the shredding assembly 202. This reduces the frequent blockages and creates a more efficient waste placement method as opposed to other known consumer waste recycling assemblies. Additionally, a user can insert the piece of consumer waste 114 into the machine without worrying about the angle of the piece of consumer waste 114.

In one embodiment, as shown in FIG. 1, an enclosure 120, or cover, is shown disposed over the recyclable waste aperture 112. The enclosure 120 is operable to translate from an open position, exposing the recyclable waste aperture 112, and a closed position, substantially sealing the recyclable waste aperture 112. FIG. 1 depicts the enclosure 120 of the assembly 100 in a partially open position. In one embodiment, the enclosure 120 may translate from the open position to the closed position through an actuator coupled to the housing 102. The enclosure 120 may translate on a track to ensure a smooth transition from the open and closed position and alignment of the enclosure 120 with the housing when in the closed position. The enclosure 120 may also translate via an electric motor that turns a plurality of gears. The plurality of gears may include a rack and pinion gear set connected to an actuator rod. The rack and gear set may be operable to convert a rotational motion of the electric motor into a linear motion to translate the enclosure 120 from the open position to the closed position. In another embodiment, the enclosure 120 may translate from the open position to the closed position after movement detected by a motion detector. The motion detector may also be activated when the user inserts the piece of consumer waste 114 into the assembly 100. Advantageously, the closed position is operable to prevent the piece of consumer waste 114 from exiting the organizational recycling assembly 100 during the shredding process. The enclosure 120 is shown in FIG. 1 as a square shaped glass panel. In other embodiments, the enclosure 120 may be made of another shape and/or a similar durable material, as would be appreciated by one of ordinary skill in the art.

The housing 102 is shown defining a recyclable waste channel 200 that tapers downwardly away from the recyclable waste aperture 112. The recyclable waste channel 200 is shown spanning from the recyclable waste aperture 112 toward the bottom surface (not shown) of the assembly 100. The recyclable waste channel 200 is shaped to direct the piece of consumer waste 114 from the recyclable waste aperture 112 toward the bottom surface (not shown), more specifically to the shredding assembly 202. The recyclable waste channel 200 includes a continuous sidewall 234 which completely surrounds the shredding assembly 202 to keep the piece of consumer waste 114 within the recyclable waste channel 200. In one embodiment, the continuous sidewall 234, or the surface of the continuous sidewall 234, is a durable material, e.g., hardened steel or tungsten, to sustain the force of the debris of the consumer waste as it gets processed by the shredding assembly 202. In other embodiments, the continuous sidewall may be plastic or another similar durable material of a hardness of approximately 60-90 Shore D.

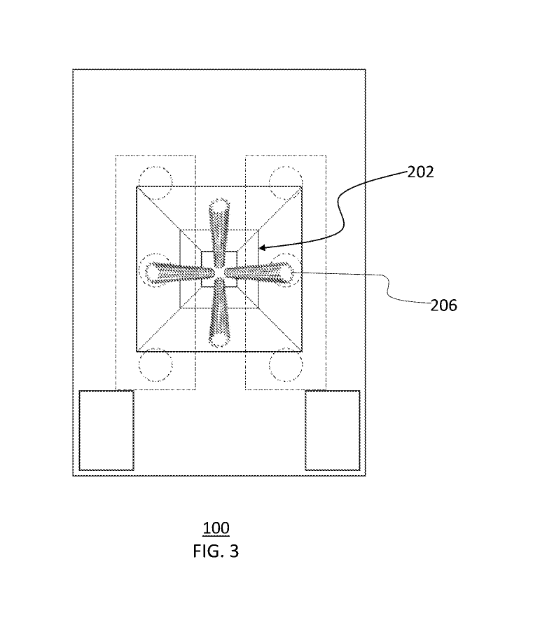

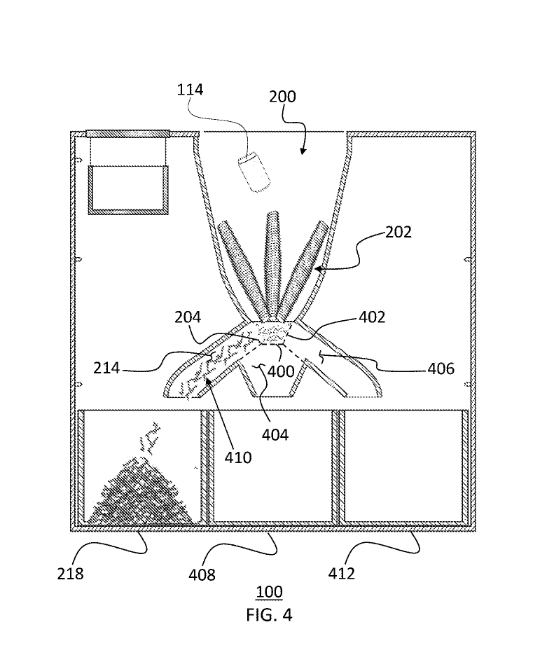

The shredding assembly 202 is schematically shown in FIG. 2 disposed within the recyclable waste channel 200. In one embodiment, the shredding assembly 202 may be referred to as a single recyclable waste processing assembly. Said another way, it has only one processing assembly where the recyclable waste 114 is directed and then subsequently directed to the appropriate channel. In another embodiment, referring now primarily to FIGS. 2 and 3, depicting the shredding assembly 202 having at least three reciprocating blade members 206. The term “reciprocating” is defined herein as moving in a back-and-forth or circular rotation. In other embodiments, the shredding assembly 202 includes less than three blade members 206, though the at least three blade members 206 configuration is preferred, for adequate processing of the piece of consumer waste 114. The term “processing” is defined herein as shredding the piece of consumer waste 114 into a plurality of recyclable waste fragments 410 (shown in FIG. 4).

In one embodiment, the blade members 206 are made with a stainless steel material, operable for processing various types of recyclable materials, including glass. Advantageously, the blade members 206 are operable to safely shred glass so that glass will not simply shatter and become hazardous when placed within the organizational recycling assembly 100. In another embodiment, the blade members 206 may be made of another durable material. Advantageously, following normal wear and tear, the blade members 206 can be inexpensively removed and replaced, without having to replace additional moving parts.

Referring again to FIG. 2, similar to the recyclable waste channel 200, FIG. 2 shows the blade members 206 tapering downwardly in a longitudinal, i.e. vertical, direction away from the recyclable waste aperture 112 and toward the bottom surface (not shown). Advantageously, the tapering configuration is operable to facilitate the piece of consumer waste 114 funneling down into the blade members 206 for processing. In one embodiment, the blade members 206 may be powered by an electrical actuator. In another embodiment, the blade members 206 may be powered by a mechanical actuator. The actuator may be operable to turn the blade members 206 in a circular motion, thereby creating a vortex. The term “vortex” is defined herein as a spiral movement which creates a vacuum in the center of the blade members 206.

In another embodiment, the blade members 206 may be of a circular shape and positioned perpendicular, i.e. horizontal, with respect to the recyclable waste aperture 112. In one embodiment, the blade members 206 may be operable to move in a translation motion, i.e. a back and forth motion, toward each other and away from each other to crush the piece of consumer waste 114, e.g. consumer waste that is of a glass material. In yet another embodiment, the blade members 206 may include at least two blade members 206 positioned in the longitudinal direction adjacent at least two blade members 206 positioned in the perpendicular direction. The blade members 206 may be operable to shred the piece of consumer waste 114 in a two-step process, wherein the longitudinal blade members 206 shred the piece of consumer waste 114 prior to the perpendicular blade members 206 shredding the piece of consumer waste 114. In the alternative, the blade members 206 may be operable to alternate back and forth between shredding the piece of consumer waste 114 using the longitudinal blade members 206 and the horizontal blade members 206. In further embodiments, the shredding assembly 202 includes a push rod that is operable to apply a downward force at an upward portion of the blade members 206 to force the piece of consumer waste 114, e.g. debris, downward toward the lower end of the tapered blade members 206.

FIG. 2 shows the housing 102 defining a first recyclable waste distribution channel 214 and a second recyclable waste distribution channel 216. The recyclable waste distribution channels will be referred to herein as “distribution channels.” In other embodiments, the housing may define a plurality of distribution channels 214, 216. The distribution channels 214, 216 are separate passages for the piece of consumer waste 114 to travel from the recyclable waste channel 200 through the distribution channels 214, 216, to a first recyclable waste container 218 and a second recyclable waste container 220. The first distribution channel 214 is operable to receive a piece of consumer waste 114 that is of a material different than the material of the piece of consumer waste 114 going to the second distribution channel 216. Advantageously, positioning the shredding assembly 202 above the distribution channels 214, 216, provides a configuration such that the piece of consumer waste 114 is shredded prior to being organized, providing less risk of the piece of recyclable waste 114 becoming clogged within the distribution channels 214, 216. This reduces the potential maintenance costs associated with the piece of consumer waste 114 becoming clogged within the organizational recycling assembly 100. In one embodiment, to further reduce the risk of the piece of consumer waste 114 from becoming clogged within the distribution channels 214, 216, the organizational recycling assembly 100 includes a reverse button that is operable to reverse the motor when the shredding assembly 202 is clogged. The reverse button signals the blade members 206 to rotate in the counterclockwise direction to dislodge the piece of consumer waste 114 from the shredding assembly 202.

FIG. 2 shows the first distribution channel 214, having a first sidewall 210 opposite a second sidewall 222. Likewise, the second distribution channel 216 is shown having a third sidewall 236 opposite a fourth sidewall 238. In one embodiment, the sidewalls 210, 222, 236, 238 are made of a durable material, e.g., a metal similar that used for the sidewall 234 or outer surface thereon. In another embodiment, the walls 210, 222, 236, 238 may be made of plastic or another material of similar durability.

In one embodiment, the first distribution channel 214 and the second distribution channel 216 are fluidly coupled to the recyclable waste channel 200 through at least one waste distribution divider 204. The term “fluidly coupled” is defined herein as having the ability to exchange fluid. When the first or second distribution channels 214, 216 are fluidly coupled with one another there is, in one embodiment, a gap or opening between the same of at least approximately 1-2 inches. The assembly 100 can also be seen having a drain 226 at the bottom surface (not shown). Advantageously, the drain 226 is operable to permit fluid accumulated from the processing of the recyclable waste 114 to be emptied from the assembly. The drain 226 may also include a plug that is removably couplable to the drain to seal drain 226.

While a single waste distribution divider 204 may be used to fluidly seal and open each of the distribution channels 214, 216 with respect to the recyclable waste channel 200, in the preferred embodiment, a second, and independent, waste distribution divider 224 is employed with the second waste distribution channel 216. The waste distribution dividers 204, 224, are shown at a distal end 212 of the recyclable waste channel 200. In one embodiment, the waste distribution dividers 204, 224 are substantially enclosed to prevent the recyclable waste 114 from entering the incorrect distribution channel. Therefore, most of the dividers are surrounded by the continuous sidewalls 210, 222, 238, 236 and free of any apertures located thereon. FIG. 2 also shows the waste distribution dividers 204, 224 disposed at an acute angle 230 with respect to a general exit direction of the piece of consumer waste 114 as it leaves the recyclable waste channel 200, indicated by the arrow 240. The acute angle configuration operates to permit the accumulated (or pass-through) waste from the shredding assembly 202 to fall into the appropriate channel and not remain behind (upstream of the dividers) after the shredding process.

Referring briefly back to FIG. 1, the housing 102 can also be seen having an electronic display 110 with one or more buttons, e.g., buttons 108, 122. In one embodiment, the electronic display 110 may be a touch-screen monitor. In another embodiment, the electronic display 110 may be a light-emitting diode (LED) display. The electronic display 110, more specifically the one or more buttons 108, 122, is communicatively coupled to the waste distribution dividers 204, 224. Further, the assembly 100 can also be seen having one or more drawers 124, 126 disposed within the housing and, in one embodiment, apertures sized to access the drawers 124, 126. These drawers 124, 126 may be used to house batteries, oil, or other material inappropriate or hazardous for shredding.

Referring now primarily to FIGS. 1 and 2, in one embodiment, the waste distribution divider 204 is operable to open and close in response to the user pressing at least one of the buttons 108, 122. In another embodiment, the waste distribution dividers 204, 224, are operable to open and close in response to the user pressing each respective button 108, 122. The buttons 108, 122, respectively, correspond to the material of the piece of consumer waste 114 desired to be processed and organized by the user.

In one embodiment, the button 108 corresponds to the user selection of a first piece of consumer waste 114, that may be, for example, a plastic material. The button 108 is operable to selectively move the waste distribution divider 204 from an open position with one of at least one of the distribution channel and the second distribution channel 216 fluidly coupled to the recyclable waste channel 200 and to a closed position with one of the at least one of the distribution channel and the second distribution channel 216 sealed with the recyclable waste channel 200. Said another way, the button 108 may be operable to selectively move the waste distribution divider 204 to open the distribution channel, allowing the piece of consumer waste 114 to flow from the recyclable waste channel 200 through the first distribution channel 214, while simultaneously prohibiting access to the second recycling waste distribution channel 216 (or any other channels in the assembly) by placing the divider 224 in a closed position. Likewise, the button 108 may also be operable to selectively move the waste distribution divider 224 to an open position to allow the piece of consumer waste 114 to flow from the recycling waste channel 200 and through the second distribution channel 216, while simultaneously closing the first divider 204. The direction or path of the waste 114 will depend on the type of waste being recycled.

Said even further, when the dividers 204, 224 are in the open position, it results in a closed position whereby any of the remaining waste distribution channels, e.g., the second recyclable waste distribution channel 216 is sealed from the recyclable waste channel. Those of skill in the art will appreciate that the recyclable waste distribution channels that are sealed are those which do not correspond to the material selected by the user. Said another way, the open position of the divider is based on a type of the piece of consumer waste selected by a user, e.g., plastic.

In another embodiment, the second button 122 corresponds to the user selection of a second piece of recyclable waste, e.g., material 232, different than the first piece of consumer waste 114, e.g., a glass material. In one embodiment, the second button 122 may be operably configured to selectively move the second waste distribution divider 224 to at least one of an open position with the second distribution channel 216 fluidly coupled to the recyclable waste channel 200 and to a closed position with the recyclable waste channel 200. Said another way, the second button 122 may be operable to open and close the second waste distribution divider 224 to allow the piece of consumer waste 114 to travel from the recyclable waste channel 200 to the second distribution channel 216. In other embodiments, the organizational recycling assembly 100 may include a plurality of waste distribution dividers, distribution channels, and corresponding waste distribution containers.

To detect the type of recyclable material, in one embodiment, the organizational recycling assembly 100 includes a sensor. In one embodiment, the sensor may decipher the type of material according to a bar code coupled to the piece of consumer waste 114. In another embodiment, the sensor may be operable to detect whether the type of material is metal or non-metal. In yet another embodiment, the sensor may be operable to decipher the type of material according to the weight of the material. In yet a further embodiment, the sensor may be operable to detect the type of material according to a photographic recognition system stored within a microprocessor. In other embodiments, the sensor may be operable to detect the type of recyclable material according to another type of sensor. To detect the consumer waste, the assembly 100 may utilize one or more platform(s) disposed upstream of the shredding assembly 202 as a resting position for the waste 114 while being examined by the sensor. Advantageously, the sensor is operable to detect the type of material independent of the position in which the piece of consumer waste 114 is input into the recycling waste aperture 112. In other words, the user may place the piece of consumer waste 114 into the recycling waste aperture from at least one of a vertical and horizontal position for detection of the type of material by the sensor.

To accomplish the communication between the electronic display 110 and the waste distribution divider 204, the button 108 is operable to serve as an input device for a microcontroller coupled to an electric motor mechanically coupled to the divider 204. In use, the microcontroller receives input from the button 108. The microcontroller is operable to send a signal to the electronic motor coupled to a plurality of gears. The plurality of gears are coupled to the waste distribution divider 204. In use, the signal sent by the electronic motor is operable to turn the plurality of gears in order to rotate the waste distribution divider 204 to at least one of an open and closed position. Advantageously, the microcontroller and electric motor require minimal energy capacity, making utility costs minimal for the user.

In another embodiment, the organizational recycling assembly 100 may include a transmitter, a receiver, a motor, and a power source operable to communicatively couple the electronic display 110 with the waste distribution divider 204, or any other divider utilized by the assembly 100. In this embodiment, the button 108 may be the transmitter, operable to send radio waves to the receiver. Once the radio waves are received by the receiver, the receiver may be operable to activate the motor to open and close the waste distribution divider 204. In one embodiment, the power source may be a battery. In another embodiment, the power source may be an electrical outlet or solar, wind, or other means.

FIG. 2 also depicts at least one nozzle 228 operably configured to introduce a pressurized fluid in a direction toward the waste distribution divider 204 and the second waste distribution divider 224, when in the open position. In one embodiment, the pressurized fluid may be air. In another embodiment, the pressurized fluid may be water. The nozzle 228 may be connected to a valve and a microcontroller. In use, the microcontroller sends a signal to the nozzle 228 to release the pressurized fluid. Advantageously, the pressurized fluid released from the nozzle 228 is operable to direct the piece of consumer waste 114 toward the distribution channels 214, 216, thereby preventing the piece of consumer waste 114 from becoming lodged within the recyclable waste channel 200. The nozzle 228 may also be advantageously placed to provide an additional force to any unprocessed waste through the shredding assembly. An additional benefit presented by pressurized fluid release from the nozzle 228 is that the fluid is operable to allow fluid that may leak from the piece of recyclable material, to flow through the recyclable waste channel 200 to the drain 226. To facilitate the flow of fluid from the recyclable waste channel 200 to the drain 226, the assembly may utilize a drain 242 disposed proximal to the area downstream of the shredding assembly 202 in the recyclable waste channel 200. The drain 226 can be conveniently removed and emptied to prevent built up of fluid within the organizational recycling assembly 100. As shown in FIGS. 2 and 4, nozzles may be disposed and orientated in various positions around the internal housing 102 of the assembly 100 to facilitate in the transportation of waste and, in some embodiments, provide a means for self-cleaning the channels disposed therein. As an added advantage, in one embodiment, the nozzles may be operable to rinse and clean the consumer waste, prior to the consumer waste entering the recyclable waste containers 218, 220, thereby eliminating germs and residue from the consumer waste.

The first distribution channel is shown having the first recyclable waste container 218 disposed below, and in fluid communication with, the first distribution channel 214. The term “fluid communication” is defined herein as operable to provide continuous flow. Likewise, the second recyclable waste container 220 is also shown disposed below, or downstream of, and in fluid communication with, the second distribution channel 216. The recyclable waste containers 218, 220, can conveniently be removed by the user so that the consumer waste can be emptied from the recyclable waste containers 218, 220. Advantageously, because each recyclable waste container 218, 220 corresponds to a different type of material of recyclable waste, the consumer waste is organized prior to removing the recyclable waste containers 218, 220. Accordingly, the user does not have to spend time organizing the recyclable waste into different categories for pick up or drop off at a recycling facility.

The recyclable waste containers 218, 220 may utilize bags or another removable medium to facilitate transportation of the consumer waste after it is shredded. In one embodiment, the recyclable waste containers 218, 222 may be lined with the bags, such that the consumer waste goes directly from the distribution channels 214, 216 into the bags. The bags may be made from the type of the material received by the recyclable waste containers 218, 220. For example, the bag lining the recyclable waste container designated for receiving aluminum may be made of aluminum, the bag lining the recyclable waste container designated for receiving paper may be made of paper, etc. Advantageously, the bags may also be labeled with the type of material it contains to facilitate the sorting and processing of the consumer waste at the recycling facility, thereby reducing the machine's overall carbon footprint.

Referring now to FIG. 4, a cross-sectional view of the organizational recycling assembly 100 along section B-B is shown. The assembly 100 is shown with the waste distribution divider 204 and two other waste distribution dividers 400, 402. The two other waste distribution dividers 400, 402 can be seen separating two other waste distribution channels 404, 406. Similar to the first and second waste distribution channels 214, 216, the other channels 404, 406 are disposed downstream or below the shredding assembly 202 and the recyclable waste channel 200.

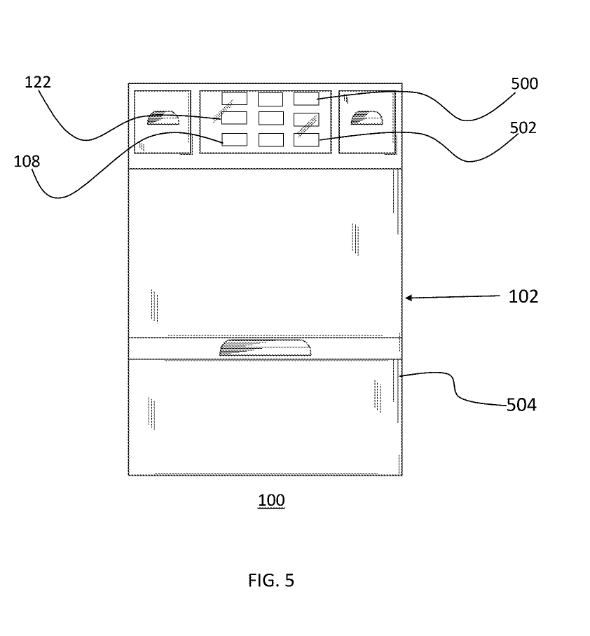

Referring now primarily to FIGS. 4 and 5, the organizational recycling assembly 100 may include a first button 108, a second button 122, a third button 500, and a fourth button 502. The amount, shape, configuration, and size of the buttons shown in FIG. 5, however, may be varied. As discussed above, the first button 108 is operable to open and close the waste distribution divider 204 and the second button 122 is operable to open and close the divider 402. In other embodiments of the present invention, if more channels are used, additional buttons, e.g., buttons 500, 502, may be used to open and close those corresponding dividers 400, 402. As shown in FIGS. 4 and 5, the third button 500 is operable to open and close the third waste distribution divider 400 and the fourth button 502 is operable to open and close the fourth waste distribution divider 402. The buttons 108, 122, 500, 502, respectively, correspond to a piece of consumer waste 114 of a material different from one another. In use, the third button 500 is selectively moves the third waste distribution divider 400 to an open position with respect to the recyclable waste channel 404, to permit a piece of recyclable waste to travel through the third recyclable waste distribution channel 404 and into a third recyclable waste container 408. The third button 500 is also operable to move the waste distribution divider 400 to the closed position with respect to the recyclable waste channel 200 to seal the third distribution channel 400. The embodiment of the housing 102 shown in FIG. 5 is not meant to be limiting, rather the organizational recycling assembly 100 may include more than four buttons corresponding to more than four distribution channels 214, 216, 404, 406 and corresponding recyclable waste containers 218, 408, 412.

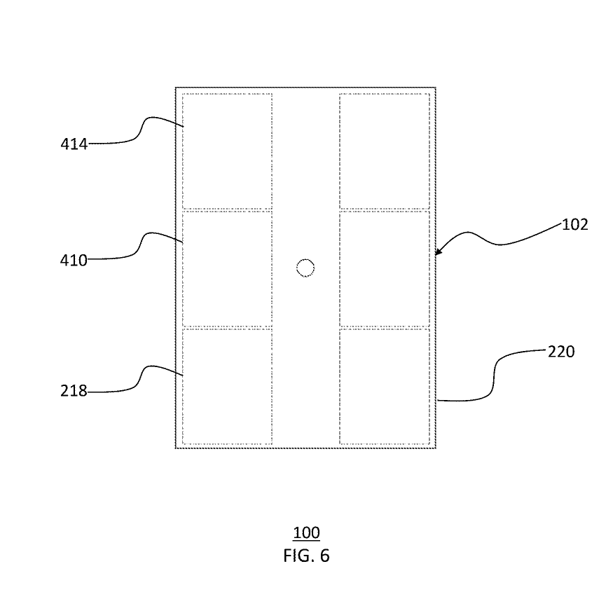

Referring now to FIG. 6, showing the organizational recycling assembly 100 having a plurality of recyclable waste containers, where the number of containers employed by the assembly 100 may vary. Advantageously, each recyclable waste container is operable to receive the piece of consumer waste 114 (FIG. 1) of a material different from each other. The size of the recyclable waste containers varies, but is preferably approximately 8-10 inches wide and approximately 10-12 inches in height. Each of the recyclable waste containers may be slidably, and removably, coupled to the housing 102 through a drawer 504 (FIG. 5). Advantageously, the recyclable waste containers can be removed from the drawer 504 (FIG. 5) for convenient emptying of the plurality of pieces of recyclable waste 114. Moreover, the recyclable waste containers, are organized, and may be labeled, according to the recyclable material, eliminating the need for the user to separate and organize the materials for the recycling process. Additionally, the recyclable waste containers may include a vibration system that is designed to vibrate the recyclable waste containers so that the recyclable material goes into the recyclable waste containers, as opposed to remaining on the sides of the recyclable waste containers. The vibration system may be installed within the bottom surface of the recyclable waste containers. The vibration system may include a control unit having a small motor which drives a gear. The gear may be attached to a small weight that it is mounted off-center on the gear. When the motor spins, the off-center mounting of the gear and weight cause the vibration system to vibrate.

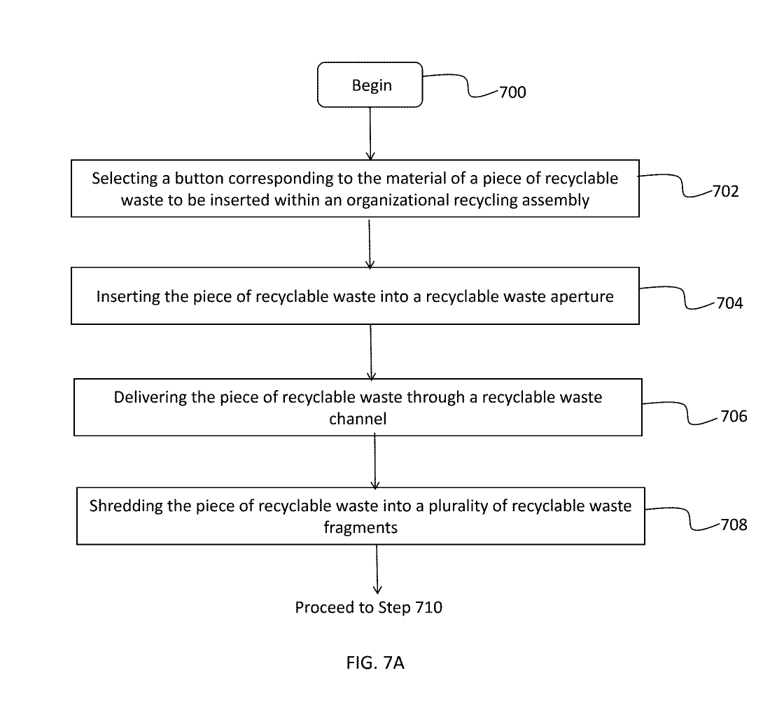

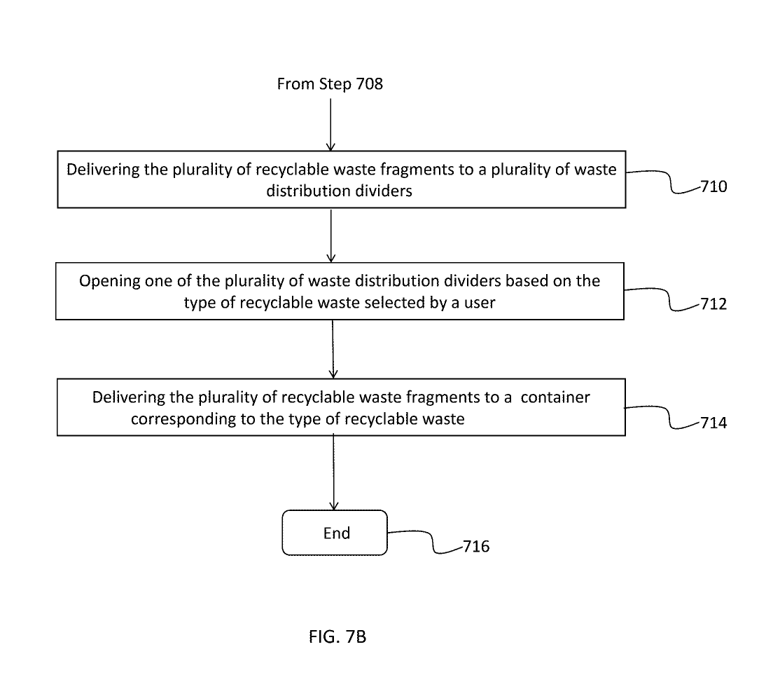

Referring now to FIG. 7A, read in conjunction with FIG. 1, a method of shredding, processing and organizing and recyclable waste is depicted in a process flow diagram. The process of FIG. 7A begins at step 700 and moves directly to step 702, which includes selecting at least one button 108 corresponding to the material of the piece recyclable waste 114 being placed within the organizational recycling assembly 100. In step 704, the process continues with the user inserting the piece of consumer waste 114 into a recyclable waste aperture 112.

With reference still to FIG. 7A, read in conjunction with FIGS. 2 and 4, in step 706, the piece of consumer waste 114 is delivered through a recyclable waste channel, e.g., channel 200, to the shredding assembly 202. The piece of consumer waste 114 travels to the shredding assembly 202 disposed within the recyclable waste channel 200. In step 708, the shredding assembly 202 shreds the piece of consumer waste 114 into a plurality of recyclable waste fragments 410. While referred to herein as a “piece of consumer waste,” the waste 114 may be made of one or more pieces.

The process continues to step 710 of delivering the plurality of recyclable waste fragments 410 to the plurality of waste distribution dividers 204, 224 (or any other dividers employed with the assembly 100). The plurality of waste distribution dividers 204, 224, correspond to the type of recyclable waste 114 placed within the organizational recycling assembly 100 and selected by the user. In step 712, the method continues by opening at least one of the plurality of waste distribution dividers 204, 224, based on the type of recyclable waste 114 selected by the user. As shown in FIG. 4, the divider 204 is shown in an open position to permit the transmission of waste fragments 410 to the channel 214, and ultimately to the recyclable waste container 218. In step 714, the plurality of recyclable waste fragments are delivered, through the first distribution channel 214, to the recyclable waste container 218 that corresponds to the type of recyclable waste 114 selected by the user by the button. The method ends at step 716.

An organizational recycling assembly and method of shredding, processing and organizing recyclable waste has been disclosed that features a housing defining a recyclable waste aperture sized to receive a piece of consumer waste, a recyclable waste channel, a central shredding assembly disposed within the recyclable waste channel, a plurality of waste distribution dividers, a plurality of recyclable waste distribution channels, and a plurality of recyclable waste containers disposed below the recyclable waste distribution channels. The organizational recycling assembly also includes at least one button coupled to the housing and operably configured to selectively move at least one of the waste distribution dividers to an open position to allow the consumer waste to flow to the appropriate recyclable waste distribution channel and recyclable waste container, based on the type of consumer waste selected by a user. Other features of the invention have been disclosed that add to the shredding and organizing of the consumer waste, but are not intended to be limited to the particular details disclosed herein.

What is claimed is:

1. An organizational recycling assembly comprising:
a housing having an outer surface that includes a top surface and a bottom surface, the housing:
defining a recyclable waste aperture disposed on the outer surface, the recyclable waste aperture sized to receive a piece of consumer waste;
defining a recyclable waste channel spanning from the recyclable waste aperture toward the bottom surface of the housing; and
defining a first recyclable waste distribution channel and a second recyclable waste distribution channel, both the first and second recyclable waste distribution channels are located downstream the recyclable waste channel and operable to be fluidly coupled to the recyclable waste channel through at least one waste distribution divider;
a shredding assembly disposed within the recyclable waste channel and upstream the at least one waste distribution divider;
a first recyclable waste container disposed below, and in fluid communication with, the first recyclable waste distribution channel;
a second recyclable waste container disposed below, and in fluid communication with, the second recyclable waste distribution channel; and
at least one button coupled to the housing and operably configured to selectively move the at least one waste distribution divider to an open position fluidly coupling the recyclable waste channel to one of the at least one of the first recyclable waste distribution channel and the second recyclable waste distribution channel, the open position:
resulting in a closed position, with a remaining of the at least one of the first recyclable waste distribution channel and the second recyclable waste distribution channel sealed from the recyclable waste channel; and
based on a type of the piece of consumer waste selected by a user.

2. The organizational recycling assembly according to claim 1, further comprising:
an enclosure disposed over the recyclable waste aperture and operable to translate from an open position exposing the recyclable waste aperture and a closed position substantially sealing the recyclable waste aperture.

3. The organizational recycling assembly according to claim 1, further comprising:
an electronic display coupled to the housing and including the at least one button, the electronic display communicatively coupled to the at least one waste distribution divider.

4. The organizational recycling assembly according to claim 1, wherein the shredding assembly further comprises:
at least three reciprocating blade members extending in a longitudinal direction away from the recyclable waste aperture for processing the piece of consumer waste.

5. The organizational recycling assembly according to claim 4, wherein:
the at least three reciprocating blade members taper downwardly in a direction toward the bottom surface of the housing.

6. The organizational recycling assembly according to claim 1, wherein:
the at least one waste distribution divider is substantially enclosed.

7. The organizational recycling assembly according to claim 1, further comprising:
a first waste distribution divider separating the first recyclable waste distribution channel and the recyclable waste channel; and
a second waste distribution divider separating the second recyclable waste distribution channel and the recyclable waste channel, wherein the at least one button is operably configured to selectively move at least one of the first and second waste distribution dividers to the open position.

8. The organizational recycling assembly according to claim 7, further comprising:
a first button coupled to the housing, the first button corresponding to a user selection of a first piece of consumer waste and operably configured to selectively move the first waste distribution divider to the open position; and
a second button coupled to the housing, the second button corresponding to the user selection of a second piece of consumer waste and operably configured to selectively move the second waste distribution divider to the open position, the second piece of consumer waste is of a material different than a material of the first piece of consumer waste.

9. The organizational recycling assembly according to claim 8, wherein:
the first piece of consumer waste is of a plastic material; and
the second piece of consumer waste is of a glass material.

10. The organizational recycling assembly according to claim 8, further comprising:
a third waste distribution divider separating a third recyclable waste distribution channel and the recyclable waste channel, the third waste distribution divider communicatively coupled to a third button that is operably configured to selectively move the third waste distribution divider to the open position, the third recyclable waste distribution channel located downstream of the recyclable waste channel; and
a third recyclable waste container disposed below, and in fluid communication with, the third recyclable waste distribution channel.

11. The organizational recycling assembly according to claim 10, wherein:
the first button, the second button, and the third button each correspond to a consumer waste of a material different from one another.

12. A method of organizing and processing recyclable waste, the method comprising the steps of:
selecting, through at least one button coupled to a housing of a recycling assembly, one of a plurality of types of consumer waste for processing by the recycling assembly;
inserting a piece of consumer waste into a recyclable waste aperture defined by the housing, the piece of consumer waste corresponding to the one of the plurality of types of consumer waste selected by a user;
delivering, through a recyclable waste channel defined by the housing, the piece of consumer waste to a shredding assembly disposed within the recyclable waste channel;
shredding the piece of consumer waste into a plurality of consumer waste fragments;
delivering the plurality of consumer waste fragments to a plurality of waste distribution dividers, each of the plurality of waste distribution dividers corresponding to each of the plurality of types of consumer waste for processing by the recycling assembly;
opening one of the plurality of waste distribution dividers based on the one of the plurality of types of consumer waste selected by the user; and
delivering the plurality of consumer waste fragments, through a recyclable waste distribution channel defined by the housing, to one of a plurality of containers corresponding to the one of the plurality of types of consumer waste selected by the user, the plurality of containers disposed within the housing.

13. The method according to claim 12, further comprising:
closing the one of the plurality of waste distribution dividers opened based on the one of the plurality of types of consumer waste selected by the user so as to seal the recyclable waste distribution channel with the recyclable waste channel.

14. The method according to claim 12, further comprising:
introducing a pressurized fluid, through at least one nozzle, in a direction toward the one of the plurality of waste distribution dividers opened based on the one of the plurality of types of consumer waste selected by the user.

15. An organizational recycling assembly comprising:
a housing having an outer surface defining a recyclable waste aperture sized to receive a piece of consumer waste, the housing defining a recyclable waste channel spanning from the recyclable waste aperture toward a bottom surface of the housing;
a single shredding assembly disposed within the recyclable waste channel;
a first waste distribution divider separating a first recyclable waste distribution channel and the recyclable waste channel, the first recyclable waste distribution channel and the first waste distribution divider both disposed downstream of the recyclable waste channel, the first waste distribution divider communicatively coupled to a first button that is operably configured to selectively move the first waste distribution divider to at least one of an open position with the first recyclable waste distribution channel fluidly coupled to the recyclable waste channel to permit the piece of consumer waste to enter a first recyclable waste container disposed below the first recyclable waste distribution channel and to a closed position with the first recyclable waste distribution channel sealed with the recyclable waste channel; and
a second waste distribution divider separating a second recyclable waste distribution channel and the recyclable waste channel, the second recyclable waste distribution channel and the second waste distribution divider both disposed downstream of the recyclable waste channel, the second waste distribution divider communicatively coupled to a second button that is operably configured to selectively move the second waste distribution divider to at least one of an open position with the second recyclable waste distribution channel fluidly coupled to the recyclable waste channel to permit the piece of consumer waste to enter a second recyclable waste container disposed below the second recyclable waste distribution channel and to a closed position with the second recyclable waste distribution channel sealed with the recyclable waste channel.

16. The organizational recycling assembly according to claim 15, wherein:
the first and second buttons each correspond to a consumer waste of a material different from one another.

17. The organizational recycling assembly according to claim 15, wherein:
the first and second containers are slidably, and removably, coupled to the housing.

18. The organizational recycling assembly according to claim 15, further comprising:
a third waste distribution divider separating a third recyclable waste distribution channel and the recyclable waste channel, the third recyclable waste distribution channel and the third waste distribution divider both disposed downstream of the recyclable waste channel, the third waste distribution divider communicatively coupled to a third button that is operably configured to selectively move the third waste distribution divider to at least one of an open position with the third recyclable waste distribution channel fluidly coupled to the recyclable waste channel to permit the piece of consumer waste to enter a third recyclable waste container disposed downstream the third recyclable waste distribution channel and to a closed position with the third recyclable waste distribution channel sealed with the recyclable waste channel, wherein the first, second, and third buttons each correspond to a consumer waste of a material different from one another.

19. The organizational recycling assembly according to claim 15, further comprising:
at least one nozzle operably configured to introduce a pressurized fluid in a direction toward the first and second waste distribution dividers when either is in the open position.

20. The organizational recycling assembly according to claim 15, wherein:
at least one of the first and second waste distribution dividers are disposed at acute angle with respect to a plane defined by a general exit direction of the piece of consumer waste as it leaves the recyclable waste channel.
